(19) United States
(12) Patent Application Publication
(10) Pub. No.: US 2014/0282004 A1
(43) Pub. Date: Sep. 18, 2014

(54) System and Methods for Recording and Managing Audio Recordings

(71) Applicant: Headliner Technology, Inc., Lake Forest, CA (US)

(72) Inventor: Tom Birmingham, Lake Forest, CA (US)

(73) Assignee: Headliner Technology, Inc., Lake Forest, CA (US)

(21) Appl. No.: 14/214,421

(22) Filed: Mar. 14, 2014

Related U.S. Application Data
(60) Provisional application No. 61/785,044, filed on Mar. 14, 2013.

(51) Int. Cl. G06F 3/16

(52) U.S. Cl. CPC G06F 3/167
USPC 715/727

(57) ABSTRACT

A system and method for recording and managing a plurality of sound takes for an at least one sound part associated with a sound project are disclosed. In at least one embodiment, a primary user is capable of selectively adding at least one sound part to the sound project, and at least one sound take for a given sound part. The primary user is also able to select one of the previously recorded sound takes for each of the at least one sound parts for simultaneous playback during the recording of any new sound takes.

This application claims the benefit of U.S. Provisional Patent Application 61/785,044, filed Mar. 14, 2013, the entire disclosure of which is incorporated herein by reference.

Mobile devices of today offer speed and storage capabilities comparable to desktop computers from less than ten years ago, rendering them surprisingly suitable for real-time sound synthesis and other musical applications. As a result, some modern mobile phones support audio and video playback quite capably.

Mobile devices have the advantages of ubiquity, strength in numbers, and ultramobility, making it feasible to (at least in theory) bring together artists for jam sessions, rehearsals, and even performance almost anywhere, anytime.

Applications deployable to modern handheld devices present significant challenges imposed by processor, memory, screen size and other limited computational resources thereof and/or within communications bandwidth and transmission latency constraints typical of wireless networks. Accordingly, a need exists for further development of music collaboration systems.

### SUMMARY

Aspects of the present specification provide a user interface (also referred to herein as a user device) comprising a processor, an input device, a display device, and a memory device storing instructions. Upon execution of the instructions by the processor, in cooperation with the display device, the input device and the memory device are configured to: a) respond to receiving a request to record a song take for a song part, and b) determine whether the song take is the first song take to be recorded for the song part. The user interface may, when executed by the processor, cause the processor, in cooperation with the display device, the input device and the memory device, to respond to receiving a request to record a song take for a song part, and determine whether the song take is the first song take to be recorded for the song part. The user interface may, in response to a determination that the song take is the first song take to be recorded for the song part, record the song take for the song part; and after the song take is recorded, assign a time to the song part based on the length of the recorded song take. The user interface may, in response to a determination that the song take is not the first song take to be recorded for the song part, record the song take for the song part. In other aspects, user interface may, when executed by the processor, cause the processor to add an additional song part, may cause the processor to adjust the assigned time, may cause the processor to, in cooperation with a displayed scroll bar, receive a request to adjust the assigned time, or may cause any combination thereof. The user interface may also include a recording device configured to operate with the processor to record the song takes. The user interface is capable of recording a variety of different song parts including, without limitation, a string part, a woodwind part, a keyboard part, a percussion part and/or a vocal part.

Other aspects of the present specification provide a user interface disclosed herein that may, when executed by the processor, cause the processor, in cooperation with the display device, the input device and the memory device, to display a plurality of song takes recorded for a first song part, display a plurality of song takes recorded for a second song part, receive a request to select for playback a song take from the plurality of song takes recorded for first song part, receive a request to select for playback a song take from the plurality of song takes recorded for second song part; and receive a request to play the selected song takes. In response to a request to play the selected song takes, the user interface, when executed by the processor, causes the processor to simultaneously play the selected song takes. In other aspects, when the instructions are executed by the processor, the processor, in cooperation with the display device, the input device and the memory device are configured to: display a plurality of song takes recorded for a first song part, display a plurality of song takes recorded for a second song part, receive a request to select for playback a song take from the plurality of song takes recorded for the first song part, receive a request to select for playback a song take from the plurality of song takes recorded for the second song part; and receive a request to play the selected song takes. In response to a request to play the selected song takes, the user interface, when executed by the processor, causes the processor to simultaneously play the selected song takes.

Yet other aspects of the present specification provide a user interface disclosed herein that may, when executed by the processor, cause the processor, in cooperation with the display device, the input device and the memory device, to display a plurality of song takes recorded for a first song part, display a plurality of song takes recorded for a second song part, receive a request to select for playback a song take from the plurality of song takes recorded for first song part, receive a request to select for playback a song take from the plurality of song takes recorded for second song part; receive a request to record a song take for an additional song part, determine whether the song take is the first song take to be recorded for the additional song part, and receive a request to play the selected song takes. In response to a request to play the selected song takes, the user interface may, when executed by the processor, cause the processor to record a song take for the additional song part while simultaneously play the selected song takes.

Still other aspects of the present specification provide a user interface disclosed herein that may, when executed by the processor, cause the processor, in cooperation with the display device, the input device and the memory device, to display a plurality of song takes recorded for one or more song parts; the one or more song parts including a first song part and a second song part, receive a request to select for playback one song take from the plurality of song takes recorded for first song part, receive a request to select for playback each song take from the plurality of song takes recorded for second song part, receive a request to sequentially play the one song take from the plurality of song takes recorded for the first song part with each song take from the plurality of song takes recorded for the second song part; and enable a user to vote for each song take from the plurality of song takes recorded for the second song part. In other aspects, when the instructions are executed by the processor, the processor, in cooperation with the display device, the input device and the memory device are configured to: display a plurality of song takes recorded for one or more song parts; the one or more song parts including a first song part and a second song part, receive a request to select for playback one song take from the plurality of song takes recorded for the first song part, receive a request to select for playback each song take from the plurality of song takes recorded for the second song part, receive a request to sequentially play the one song take from the plurality of song takes recorded for the first song part with each song take from the plurality of song takes recorded for the second song part; and enable a user to vote for each song take from the plurality of song takes recorded for the second song part. In other aspects, the user interface may, when executed by the processor, cause the processor to display data indicative of which song take from the plurality of song takes recorded for the second song part song take has received the most votes.

Additional features and advantages are described herein, and will be apparent from the following detailed description and figures.

### BRIEF DESCRIPTION OF THE DRAWINGS

FIG. 1 is a diagram illustrating an example network communicating system, in accordance with at least one embodiment.

FIG. 2 is a diagram illustrating an example computing device, in accordance with at least one embodiment.

FIG. 3 is a block diagram illustrating an example network comprising an information processing system and a user interface disclosed herein comprises a plurality of modules, in accordance with at least one embodiment.

FIG. 4A is a flowchart illustrating a user interface process which enables users to record a plurality of song takes for a song part, in accordance with at least one embodiment.

FIG. 4B is a flowchart illustrating a user interface process which enables users to vote for song takes for a selected song part, in accordance with at least one embodiment.

FIGS. 5A-5H are front views of a user interface disclosed herein, sequentially illustrating the steps of establishing one or more song part, recording song takes for the established one or more song parts, manipulating a song take, playing back one or more recorded song takes, and playing back one or more previously recorded song takes from established song parts while simultaneously recording a new song take from a different established song part, in accordance with at least one embodiment.

FIGS. 6A-6D are front views of an user interface disclosed herein, sequentially illustrating the steps of playing song takes of a selected song part and enabling users to vote for each song take of the selected song part, in accordance with at least one embodiment.

FIG. 7 is a block diagram illustrating an example data architecture.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

The above described drawing figures illustrate aspects of the invention in at least one of its exemplary embodiments, which are further defined in detail in the following description.

At the outset, it should be noted that while the following description describes the present system primarily in the context of recording and managing a plurality of song takes and song parts for one or more songs, this is merely done for illustrative purposes and so should not be read as limiting. Instead, in at least one embodiment, the present system and associated methods may be used in the context of recording and managing any and all types of audible sounds (i.e., songs, instrumentals, vocals, spoken word, sound effects, etc.) now known or later conceived. As such, it is expressly intended that the general term “sound” may be used interchangeably with the exemplary term “song” throughout the disclosure (i.e., “sound take,” “sound part,” “sound track,” etc.). In other words, generally speaking, the present system is used in the context of recording and managing a plurality of sound takes for an at least one sound part associated with an at least one sound project—the at least one sound project comprising one or more sound parts.

Various embodiments described herein provide system, devices and methods which enable recording a plurality of song takes for a plurality of song parts for one or more songs. In some embodiments, after the first song take for a song part is recorded, a user interface assigns a song position to the song part based on the recorded song take. In some embodiments, the user interface receives requests for previously recorded song tracks to be played back while recording subsequent song tracks. Such a configuration enables users to determine whether specific song takes mix well with other specific song takes.

In some embodiments, for a selected song part, each song take is simultaneously played back with any other selected tracks of other song parts. In some embodiments, the user interface receives a request indicative of which song take at least one user favors. Such a configuration enables users to vote which song take for a song part mixes best with other designated song takes.

The present system may be readily realized in a network communications system. FIG. 1 is a block diagram illustrating an example network communications system 100. In this example, system 100 includes user interface 104 (also referred to herein as a user device) and information processing system 102. User device 104 typically includes a user display for providing information to users and various interface elements and is preferably configured to download, install and execute various application programs. User device 104 may include a variety of devices, such as, e.g., a cellular phone, a personal digital assistant, a laptop computer, a tablet computer, a smart phone or other mobile device as well as a desktop computer. In some embodiments, user device 104 may include any mobile digital device such as Apple Inc.'s IPHONE™, IPOD TOUCH™ and IPAD™. Further, user device 104 may include smart phones based on Google Inc.'s ANDROID™, Nokia Corporation's SYNBIAN™ or Microsoft Corporation's WINDOWS MOBILE™ operating systems or Research In Motion Limited's BLACKBERRY™ etc.

User device 104 may communicate with information processing system 102 via a connection to one or more communications channels 130 such as the Internet or some other data network, including, but not limited to, any suitable wide area network or local area network. It should be appreciated that any of the devices and systems described herein may be directly connected to each other instead of over a network. At least one server 140 may be part of network communications system 100, and may communicate with information processing system 102 and user device 104.

Information processing system 102 may interact with a large number of users at a plurality of different user devices, such as, e.g., user 114 at user device 104, user 116 at user device 106, and user 118 at user device 108. Accordingly, information processing system 102 is typically a high end computer with a large storage capacity, one or more fast microprocessors, and one or more high speed network connections. Conversely, relative to a typical information processing system 102, each user device, like user device 104, 106 and 108 may include less storage capacity, a single microprocessor, and a single network connection.

It should be appreciated that users as described herein may include any person or entity which uses the presently disclosed system and may include a wide variety of parties. For example, the users described herein may refer to various different entities, including musicians, fans, students, teachers, professionals, agents, administrative users, mobile device users, private individuals, and/or commercial partners. It should also be appreciated that although the user in this specification is often described as a musician, the musician may be instead any of the users described herein.

Information processing system 102 and/or server 108 may be configured according to its particular operating system, applications, memory, hardware, etc., and may provide various options for managing the execution of the programs and applications, as well as various administrative tasks. Typically, information processing system 102 and/or server 108 may store files, programs, databases, and/or web pages in memories for use by user device 104, and/or other information processing system 102 or server 108. Information processing system 102 and server 108 operated by separate and distinct entities may interact together according to some agreed upon protocol. In addition, information processing system 102 and/or server 108 may interact via at least one network with at least one other information processing system and/or server, which may be operated independently.

The present system may be readily implemented in a computing device. FIG. 2 is a block diagram illustrating electrical systems of an example computing device. The example computing device may include any of the devices and systems described herein, including information processing system 102, user device 104, and server 108. In this example, the computing devices may include main unit 202 which preferably includes at least one processor 204 electrically connected by address/data bus 206 to at least one memory device 208, other computer circuitry 210, and at least one interface circuit 212. Processor 204 may be any suitable processor, such as a microprocessor or nanoprocessor. Processor 204 may include one or more microprocessors and/or or nanoprocessors, central processing units (CPUs), computing devices, microcontrollers, digital signal processors, or like devices or any combination thereof. Memory 208 preferably includes volatile memory and non-volatile memory. Preferably, memory 208 stores software program(s) that interact with the other devices in system 100 as described below. This program may be executed by processor 204 in any suitable manner. In an embodiment, memory 208 may be part of a “cloud” such that cloud computing may be utilized by information processing system 102, user device 104, and server 108. Memory 208 may also store digital data indicative of documents, files, programs, web pages, etc. retrieved from information processing system 102, user device 104, and server 108 and/or loaded via input device 214.

Interface circuit 212 may be implemented using any suitable interface standard, such as an Ethernet interface and/or a Universal Serial Bus (USB) interface. At least one input device 214 may be connected to interface circuit 212 for entering data and commands into main unit 202. For example, input device 214 may be at least one of a keyboard, mouse, touch screen, track pad, track ball, isopoint, image sensor, character recognition, barcode scanner, and a voice recognition system.

As illustrated in FIG. 2, at least one display device 260, printers, speakers, and/or other output devices 262 may also be connected to main unit 202 via interface circuit 212. Display device 260 may be a cathode ray tube (CRTs), a liquid crystal display (LCD), a light emitting diode (LED) display, a plasma display, a three-dimensional display, a holographic display, or any other suitable type of display device. Display device 260 may be configured to generate visual displays during operation of information processing system 102, user device 104, and/or server 108. For example, display device 260 may provide a user device, which will be described in further detail below, and may display at least one web page received from information processing system 102, user device 104, and/or server 108. A user device may include prompts for human input from user 114 including links, buttons, tabs, checkboxes, thumbnails, text fields, drop down boxes, etc., and may provide various outputs in response to the user inputs, such as text, still images, videos, audio, and animations.

At least one storage device 266 may also be connected to main device or unit 202 via interface circuit 212. At least one storage device 266 may include at least one of a hard drive, CD drive, DVD drive, and other storage devices. At least one storage device 266 may store any type of data, such as data which may be used by information processing system 102, user device 104, and/or server 108.

Information processing system 102, user device 104, and/or server 108 may also exchange data with other network devices 270 via a connection to network 106. Network devices 270 may include at least one server 280, which may be used to store certain types of data, and particularly large volumes of data which may be stored in at least one data repository 282. Server 280 may include any kind of data 284. Server 280 may store and operate various applications relating to receiving, transmitting, processing, and storing the large volumes of data. It should be appreciated that various configurations of at least one server 280 may be used to support and maintain system 100. In some embodiments, server 280 is operated by various different entities, including private individuals, administrative users and/or commercial partners. Also, certain data may be stored in information processing system 102, user device 104, and/or server 108 which is also stored on server 280, either temporarily or permanently, for example in memory 208 or storage device 266. The network connection may be any type of network connection, such as, e.g., an Ethernet connection, a digital subscriber line (DSL), a telephone line, a coaxial cable, or a wireless connection.

Access to information processing system 102, user device 104, and/or server 108 can be controlled by appropriate security software or security measures. A user's access can be defined by information processing system 102, user device 104, and/or server 108 and be limited to certain data and/or actions. Accordingly, users of system 100 may be required to register with information processing system 102, user device 104, and/or server 108.

As noted previously, various options for managing data located within information processing system 102, user device 104, and/or server 108 and/or in server 280 may be implemented. A management system may manage security of data and accomplish various tasks such as facilitating a data backup process. The management system may update, store, and back up data locally and/or remotely. A management system may remotely store data using any suitable method of data transmission, such as via the Internet and/or other networks 106.

The present system comprises a network structure including an information processing system and a user device. FIG. 3 is a block diagram illustrating an example network structure 300. Network structure 300 includes information processing system 302 which is in communication with user device 304. As described above, in some embodiments, information processing system 302 is operated by an entity such an administrative user. It should be appreciated that information processing system 302 and user device 304 illustrated in FIG. 3 may be implemented as information processing system 102 and musician interface 104, respectively.

A user device disclosed herein comprises a plurality of modules. As shown in FIG. 3, a user device 304 may include database system 310, song part generation module 312, song take generation module 314, song take time assignment module 316, song take edit module 318, playback module 320 and audition module 322. Database system 310, song part generation module 312, song take generation module 314, song take time assignment module 316, song take edit module 318, playback module 320 and audition module 322 may include software and/or hardware components, such as a field programmable gate array (FPGA) or an application specific integrated circuit (ASIC), which performs certain tasks. Database system 310, song part generation module 312, song take generation module 314, song take time assignment module 316, song take edit module 318, playback module 320 and audition module 322 may advantageously be configured to reside on an addressable storage medium and configured to be executed on one or more processors. Thus, database system 310, song part generation module 312, song take generation module 314, song take time assignment module 316, song take edit module 318, playback module 320 and audition module 322 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Database system 310 may include a wide variety of data. In some embodiments the data may be stored temporarily or permanently.

Song part generation module 312 is configured to generate and display a song part. In one embodiment, song part generation module 312 generates and displays a song part in response to a selection of a displayed add song part button. In another embodiment, song part generation module 312 generates and displays a song part based on a downloaded song.

Song take generation module 314 is configured to record one or more song takes from a song part. In an embodiment, song take generation module 314 may generate and display the recorded song take for a selected song part.

Song take time assignment module 316 is configured to assign a designated time in a song take.

Song take edit module 318 is configured to add, delete or change a characteristic or parameter of a song take. In some embodiments, song take edit module 318 may enable a user to like a recorded song take, edit a recorded song take or delete a recorded song take.

Playback module 320 is configured to simultaneously play back a selected song take from one or more song parts.

Audition module 322 is configured to sequentially play each song take for a selected song part in association with one or more selected song takes from one or more other song parts. In some embodiments, audition module 322 enables users to vote for a song take while the song take is playing. In still further embodiments, audition module 322 enables users, such as fans, to select their own song takes in order to create their own unique mix of song takes for download.

Although the above has been shown using information processing system 302 and musician interface 304, there can be many alternatives, modifications, and variations. For example, some of the modules of the information processing system may be expanded and/or combined. Further, in some embodiments, the functions provided by certain modules may be employed by a separate information processing system operated by a separate entity. In one example, user device 304 does not include database system 310. In this example, user device 304 may be configured to communicate with a separate database system which includes the data described in database system 310 shown in FIG. 3. Other systems may be inserted to those noted above. Depending upon the embodiment, database system 310, song part generation module 312, song take generation module 314, song take time assignment module 316, playback module 318 and audition module 320 may be replaced. Further details of these systems are found throughout the present specification.

User device 304 may process data received by information processing system 302 as well as other devices. For example, user device 304 may process data received from another user device.

It should also be appreciated that certain modules of user device 304 may be considered to be part of information processing system 302, however, for discussion purposes, any modules and any engines of the user device 304 are referred to as separate from information processing system 302.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present system comprises one or more user device processes. FIG. 4A is a block diagram illustrating a user device process which enables users to record a plurality of song takes for a song part. In aspects of this embodiment, a song part includes, for example, a string part like a guitar part, a bass part, a violin part, a viola part, a cello part, a harp part; a percussion part like a drum part, a bass drum part, a bongo part; a woodwind part like a clarinet part, a flute part, a horn part, an oboe part, a saxophone part, a trombone part, a trumpet part, or a tuba part; a keyboard part like a piano part, an organ part; or a vocal part. Preferably, process 400 is embodied in one or more software programs which are stored in one or more memories and executed by one or more processors. More specifically, a user device as disclosed herein determines whether a song take is requested to be recorded for a selected song part, as indicated by block 402. In one embodiment, a user device as disclosed herein receives a request to record a song take for a song part in response to a selection of a start/stop-pause button. As indicated by block 404, if a request to record a song take is received, a user device as disclosed herein determines whether any previously recorded song takes are playback enabled. In some embodiments, a previously-recorded song take becomes playback enabled in response to a user selection of that song take. In some embodiments, only one song take may be playback enabled for each song part.

As indicated by block 406, for the selected song part, a user device as disclosed herein determines whether the requested song take is the first song take. If the requested recording of the song take is the first song take for the selected song part, a user device as disclosed herein records the song take. In aspects of this embodiment, any previously recorded song takes having playback enabled are simultaneously played back during the recording of the song take, as indicated by block 408. After the song take is recorded, the user device assigns a time which corresponds to the selected song part, as indicated by block 410. In aspects of this embodiment, a user may request that a designated song part start at a specified time and end at a specified time. In aspects of this embodiment, a user may request that a designated song part having a specific start time be adjusted or changed to a different start time.

If the user device as disclosed herein determines that the requested recording of the song take is not the first requested song take for the selected song part, the user device records the song take. In aspects of this embodiment, any previously recorded song takes having playback enabled are simultaneously played back during the recording of the song take, as indicated by block 412. In aspects of this embodiment, the recording of the song take ends based on a previously assigned time, as indicated by block 412. In other aspects of this embodiment, when auto-record is off, the recording of the song take ends based on user input, such as, e.g., selecting the Start/Stop-Pause button 505. Thus, in at least one embodiment, the user device is capable of dynamically and automatically grouping multiple song takes related to a given song part.

In at least one embodiment, the user device is further configured to account for any latency in the recording of a given song take. In a bit more detail, known prior art systems allow the user to adjust or compensate for any latency between recorded tracks or song parts prior to actually recording said tracks or parts, which oftentimes results in a series of trial-and-error recordings and adjustments by the user in order to fine tune the amount of latency. The user device of the present system, on the other hand, allows the user to adjust the latency of a given song take after the take has been recorded. In at least one such embodiment, the user is able to selectively adjust the start time of a given song take (by entering a desired amount of time, or dragging and dropping the song take on the user interface, etc.), after recording, in order for said song take to coincide or sync with the timing of the other song parts.

Although process 400 is described with reference to the flowchart illustrated in FIG. 4A, it should be appreciated that many other methods of performing the acts associated with process 400 may be used. For example, the order of many of the steps may be changed, some of the steps described may be optional, and additional steps may be included.

FIG. 4B is a block diagram illustrating a user device process which enables users to vote for song takes for a selected song part. Preferably, process 450 is embodied in one or more software programs which are stored in one or more memories and executed by one or more processors. More specifically, user device as disclosed herein displays a first song take and a second song take for a first song part as indicated by block 452. As indicated by block 454, user device as disclosed herein then displays a third song take and a fourth song take for a second song part (e.g., a piano song part), as indicated by block 454. As indicated by block 456, user device as disclosed herein then receives a request to audition the second song part. As indicated by block 458, for each song take of the second song part, user device as disclosed herein plays back the song take, whereby: (a) any previously recorded song takes associated with the first song part having playback enabled are played back; and (b) at least one user is enabled to vote for at least one of the song takes of the second song part. Although the process is described with reference to the flowchart illustrated in FIG. 4B, it should be appreciated that many other methods of performing the acts associated with the process may be used. For example, the order of many of the steps may be changed, some of the steps described may be optional, and additional steps may be included.

A user device as disclosed herein provides the capacity to execute recording of a plurality of song takes for a plurality of song parts. After the first song take for a song part is recorded, a user device as disclosed herein assigns a song position to the song part based on the recorded song take. A user device as disclosed herein further provides the capacity to select a previously recorded song take from each song part to be played back together or while simultaneous recording a song take for a different song part. In other words, the user device is capable of selectively muting the non-selected takes of a given song part so that the selected song takes can be played back together. Such a configuration enables users to determine whether specific song takes mix well with other specific song takes. FIGS. 5A-5H generally shows an example illustrating the recording of a plurality of song takes for a plurality of song parts.

In an embodiment, a user device as disclosed herein provides the capacity to display a home screen comprising a plurality of buttons and/or a plurality of windows. Referring to FIG. 5A, a user device as disclosed herein displays, via display device 501, a home screen displaying add song part button 502; rewind button 504; start/stop-pause button 505; next take button 510; yes button 512; and no button 514. The user device may also enable the display device 501 to display start/stop-pause button 505 in various symbols like start button 506 (FIG. 5B), stop button 508 (FIG. 5E), or pause button 609 (FIG. 6D) which can toggle back and forth based on the particular command being executed and/or the next command capable of being executed. For example, start/stop-pause button 505 may be displayed as play button 506 when selecting and enabling a song part. However, when a user selects play button 506 to being recording a song take for this song part, after user input play button 506 will change shape to stop button 508, indicating that the user may stop recording of the song take. The user device may also enable the display device 501 to display song title 522 on the home screen. The default song title may be “Untitled Song.” The user device may also enable the display device 501 to display seek bar 528 which includes a draggable thumb 529 on the home screen. Seek bar 528 indicates the current progress of the song. The user device enables a user to select thumb and drag left or right to set a progress level. As discussed in more detail below, the thumb moves right as a song progresses. The user device may also enable the display device 501 to display song time window 520 and song end time window 524 on the home screen. In this example, as indicated by song end time window 524 the current song has length of four minutes. Song time window 520 indicates the current progress of the song. As indicated by song time window 520, the current song time is at the beginning of the song or at time zero.

In response to user input selection of song tile window 522, such as, e.g., a long click, a user device as disclosed herein displays, via display device 501, window 530 which includes new button 532, delete button 533, edit button 534, select button 535, mix button 536, auto-record on button 538, and auto-record off button 539. User input then selects which of the seven selections to implement. Upon selection of new button 532, a user device disclosed herein will enable user to prepare the user device to record song parts and takes for a new song. Upon selection of delete button 533, a user device disclosed herein will delete a previously recorded song stored in a database. Upon selection of edit button 534, a user device disclosed herein will enable the user to modify the text appearing in song title 522. For example, as shown in FIG. 5B, the default name “Untitled Song” has been changed to “ROCK AND ROLL.” Upon selection of select button 535, a user device disclosed herein will enable a user to select a previously recorded song from a list of songs stored on a database. Upon selection of mix button 536, a user device disclosed herein will enable a user to merge a plurality of selected song takes in order to create a single music file. Upon selection of auto-play on button 538, a user device disclosed herein will enable a user to automatically play a song take after its recording. Upon selection of auto-play off button 539, a user device disclosed herein will enable a user to turn off auto-play on feature. The user device may also enable the display device 501 to generate an audio signal and/or display a visual message in message window 526 informing the user that add song part button 502 can be selected to add a song part. An exemplary message could be “SELECT NEW BUTTON TO START NEW SONG RECORDING,” and/or “SELECT DELETE BUTTON TO DELETE SONG RECORDING,” and/or “SELECT EDIT BUTTON TO EDIT NAME OF SONG TITLE,” and/or “SELECT SELECT BUTTON TO LOAD SONG RECORDING,” and/or “SELECT MIX TO CREATE MUSIC FILE OF SELECTED SONG TAKES,” and/or “SELECT AUTO-PLAY ON BUTTON TO AUTOMATICALLY PLAY SONG TAKE AFTER RECORDING” and/or “SELECT AUTO-PLAY OFF BUTTON TO TURN OFF AUTO-PLAY ON FEATURE.”

In another embodiment, a user device as disclosed herein provides the capacity to add a song part. Referring to FIG. 5B, in response to user input selection of add song part button 502, such as, e.g., a short click, a user device as disclosed herein generates, adds, and displays, via display device 501, song part one button 560. The user device may display song part one button 560 in the upper left-hand corner of the home screen generated on display device 501. A user device may also enable display device 501 to present an indication to the user that song part one button 560 has been added. For example, the user device may generate a highlighted border and/or add a symbol and/or change the color of the background and/or change the color and/or word of song part one button 560. As another example, the user device may also generate an audio signal and/or display a visual message in song part one button 560 informing the user that the user device requires enablement to record a song part. An exemplary message could be “RECORDING OFF”, “RECORDING UNENABLED”, “RECORDING NOT ENABLED”, OR “RECORDING ENABLED: NO.”

As discussed in more detail below, song part one 560 is assigned to a designated time position. Song part one 560 has a start time, an end time and an overall length of time. As shown in FIG. 5B, because a song take has not been recorded for song part one 560, song part one does not have a designated time position. To record a song take for a song part, a user must operate with an input device to cause a song part to enable recording. As shown in FIG. 5B, song part one 560 is not enabled for recording. The user device may also enable display device 501 to generate an audio signal and/or display a visual message in message window 526 informing the user that add song part button 502 was selected and/or that song part one button 560 may be selected to enable recording of a song part. An exemplary message could be “SELECT ADD SONG PART BUTTON TO ADD SONG PART” and/or “SONG PART 1 HAS BEEN ADDED” and/or “SELECT SONG PART 1 BUTTON TO ENABLE RECORDING OF TAKE 1 FOR SONG PART 1.”

In another embodiment, a user device as disclosed herein provides the capacity to enable recording of a song take to a song part. With continued reference to FIG. 5B, in response to user input selection of song part one button 560, such as, e.g., a short click, a user device as disclosed herein enables recording of song take one for song part one. A user device may also enable display device 501 to display an indication to the user that song part one has been enabled. For example, the user device may generate a highlighted border and/or add a symbol and/or change the color of the background and/or change the color and/or word of song part one button 560. As another example, the user device may also generate an audio signal and/or display a visual message in song part one button 560 informing the user that the user device is enabled to record a song take of a song part. An exemplary message could be “RECORDING ENABLED”, “RECORDING TAKE ENABLED”, “RECORDING TAKE ONE ENABLED”, or “RECORDING ENABLED: YES.” The user device may also enable display device 501 to generate an audio signal and/or display a visual message in message window 526 informing the user that song part one is enabled and that the user may select start button 506 in order to begin recording a song take of song part. An exemplary message could be “SELECT SONG PART 1 BUTTON TO ENABLE RECORDING” and/or “SONG PART 1 ENABLED FOR RECORDING” and/or “SELECT START BUTTON TO BEGIN RECORDING TAKE 1 FOR SONG PART 1.”

In another embodiment, a user device as disclosed herein provides the capacity to initiate recording of a song take to a song part. Referring to FIG. 5C, in response to user input selection of song part one 560, such as, e.g., a long click, a user device as disclosed herein generates and displays, via display device 501, window 540 which includes audition button 542, auto-record on 543, auto-record off 544, delete button 545, edit button 546, import button 548, and artist button 549. User input then selects which of the seven selections to implement. Upon selection of audition button 542, a user device disclosed herein will enable user to prepare the user device to select a song part for audition mode which will enable the user device to play each song take from that auditioned song part in association with the particular song takes selected from one or more of the remaining song parts. Upon selection of auto-record on button 543, a user device disclosed herein will enable a user to automatically record a song take. Upon selection of auto-play off button 544, a user device disclosed herein will enable a user to turn off auto-record on feature. For example, in a typical recording mode, once song take one is recorded, all subsequent song takes will have the same time length for that song part; upon reaching the designated time length, recording of the subsequent take automatically stops. If the user selects stop button 508 before this designated time length is reached, the song take is not recorded or displayed. However, upon selection of auto-record off button 544, this feature is disabled and each song take stops recording only when the user selects stop button 508. This allows a user to record song takes of different time lengths. Upon selection of delete button 545, a user device disclosed herein will delete a previously recorded song part stored in a database. Upon selection of edit button 546, a user device disclosed herein will enable the user to modify the text appearing in song part. Upon selection of import button 548, a user device disclosed herein will enable a user to load a music file stored in a database into a song take for that song part. Upon selection of artist button 549, a user device disclosed herein will enable a user to give access privilege or permission to another user that allows the other user to add or delete song takes to that song part. The user device may also enable display device 501 to generate an audio signal and/or display a visual message in message window 526 informing the user that one of the seven selections was selected. An exemplary message could be “SELECT AUTO-RECORD ON BUTTON TO ENABLE FEATURE” and/or “SELECT AUTO-RECORD OFF BUTTON TO DISABLE FEATURE” and/or “SELECT DELETE BUTTON TO DELETE SONG PART 4” and/or “SELECT EDIT BUTTON TO EDIT SONG PART 4” and/or “SELECT IMPORT BUTTON TO IMPORT ANOTHER SONG TAKE” and/or “SELECT ARTIST BUTTON TO ASSIGN ACCESS PREVILEDGE TO ANOTHER USER.”

With continued reference to FIG. 5C, in response to user input selection of start button 506, such as, e.g., a short click, a user device as disclosed herein begins recording of song take one of song part one. A user device may also enable display device 501 to display an indication to the user that recording of song take one of song part one has started. For example, the user device may generate a highlighted border and/or add a symbol and/or change the color of the background and/or change the color and/or word of start recording button 506 and/or song part one button 560. As another example, a user device as disclosed herein may also generate an audio signal and/or display a visual message in start recording button 506 and/or song part one button 560 informing the user that the user device is recording a song part. An exemplary message could be “RECORDING”, “RECORDING TAKE”, or “RECORDING TAKE ONE.” Furthermore, as shown in FIG. 5C, a user device as disclosed herein times the recording length of song take one of song part one and this information can be displayed in song time window 520 and/or song part one button 560. For example, at the point in time illustrated in FIG. 5C, the recording of song take one of song part one has progressed to 15 seconds, as indicated by song time window 520 and song part one button 560. In addition, thumb 529 of scroll bar 528 has progressed to the right based on the current progress of the present recording. The user device may also enable display device 501 to generate an audio signal and/or display a visual message in message window 526 informing the user that song take one of song part one is being recorded and to stop the recording the user may select stop recording song take. An exemplary message could be “START BUTTON SELECTED” and/or “NOW RECORDING TAKE 1 FOR SONG PART 1” and/or “SELECT STOP BUTTON TO STOP TAKE 1 RECORDING.”

In another embodiment, a user device as disclosed herein provides the capacity to stop recording of a song take to a song part. In response to user input selection of stop button 508, such as, e.g., a short click, a user device as disclosed herein stops recording song take one of song part one. A user device may also enable display device 501 to display an indication to the user that the recording of song take one of song part one has stopped. For example, the user device may generate a highlighted border and/or add a symbol and/or change the color of the background and/or change the color and/or word of start recording button 506 and/or song part one button 560. As another example, the user device may also generate an audio signal and/or display a visual message in stop recording button 508 and/or song part one button 560 informing the user that the user device has stopped recording a song part. An exemplary message could be “RECORDING STOPPED”, “RECORDING TAKE STOPPED” or “RECORDING TAKE ONE STOPPED.” Furthermore, the user device can display, via display device 501, the total length of time of the recording in song time window 520 and/or song part one button 560.

In response to the selection of stop button 508, the user device displays take one button 562 adjacent to song part one button 560. In addition, the user device assigns a designated time to song part one based on the length of the recording. In aspects of this embodiment, when auto-record on button 543 is selected, the designated time for song take one establishes the recording length of time for all subsequent song takes for that song part, unless auto-record is off. All subsequent song takes recorded for song part one will automatically stop once 30 seconds have elapsed in their respective recordings. The user device may also receive a user request for song part to begin at a time other than zero seconds, such as, e.g., time equal to one minute. In this example, if song part one were to be assigned to start at time equal to one minute, it should be appreciated that all subsequent song takes recorded for song part one would end at one minute, thirty seconds because song take one of song part one is thirty seconds in length. In aspects of this embodiment, when auto-record off button 544 is selected, the recording for each subsequent song take for song part one will be stopped only upon user selection of stop button 508. In these aspects, the time displayed will be the time associated with the song take having the longest recording time.

The user device may also enable display device 501 to generate an audio signal and/or display a visual message in message window 526 informing the user that the recording of song take one of song part one has stopped, song take one has been added, providing details of song take one, providing instructions for a second song take, and/or providing instructions to add another song part. An exemplary message could be “STOP RECORDING BUTTON SELECTED” and/or “TAKE 1 FOR SONG PART 1 HAS BEEN ADDED” and/or “TAKE 1 FOR SONG PART 1 IS 30 SECONDS LONG” and/or “SELECT START BUTTON RECORD TAKE 2 FOR SONG PART 1” and/or “SELECT ADD SONG PART BUTTON TO ADD ANOTHER SONG PART.”

In another embodiment, a user device as disclosed herein provides the capacity to enable recording of another song take to a song part. Referring to FIG. 5D, in response to user input selection of start button 506, such as, e.g., a short click, a user device as disclosed herein initiates recording of song take two for song part one. A user device may also enable display device 501 to display an indication to the user that the recording of song take two of song part one has started. For example, the user device may generate a highlighted border and/or add a symbol and/or change the color of the background and/or change the color and/or word of start recording button 506 and/or song part one button 560. As another example, the user device may also generate an audio signal and/or display a visual message in start recording button 506 and/or song part one button 560 informing the user that the user device is recording of song take two of a song part. An exemplary message could be “RECORDING”, “RECORDING TAKE”, or “RECORDING TAKE TWO.” Furthermore, the user device times the length of the recording of song take two of a song part and this information can be displayed in song time window 520 and/or song part one button 560. In addition, thumb 529 of scroll bar 528 has progressed to the right based on the current progress of the present recording. The user device may also enable display device 501 to generate an audio signal and/or display a visual message in message window 526 informing the user that song take two of song part one is being recorded and to stop the recording the user may select stop recording song take. An exemplary message could be “START BUTTON SELECTED” and/or “NOW RECORDING TAKE 2 FOR SONG PART 1” and/or “RECORDING WILL AUTOMATICALLY END AFTER 30 SECONDS” and/or “SELECT STOP BUTTON TO STOP TAKE 2 RECORDING.”

In another embodiment, a user device as disclosed herein provides the capacity to stop another song take of a song part. With continued reference to FIG. 5D, in aspects where auto-record on button 543 is selected, once the time length for song take two reaches the designated time established for song take one, the recording of song take two automatically stops recording. Alternatively, where auto-record off button 544 is selected, the recording for song take two will be stopped only upon user selection of stop button 508. In response to an automatic or manual stop, the user device displays take two button 564 adjacent to take one button 562. A user device may also enable display device 501 to display an indication to the user that the recording of song take two of song part one has stopped. For example, the user device may generate a highlighted border and/or add a symbol and/or change the color of the background and/or change the color and/or word of stop recording button 508 and/or song part one button 526. As another example, the user device may also generate an audio signal and/or display a visual message in stop recording button 508 and/or song part one button 560 informing the user that the user device has stopped recording a song part. An exemplary message could be “RECORDING STOPPED”, “RECORDING TAKE STOPPED”, or “RECORDING TAKE TWO STOPPED.” Furthermore, the user device can display, via display device 501, the total length of time of the recording in song time window 520 and/or song part one button 560. The user device may also enable display device 501 to generate an audio signal and/or display a visual message in message window 526 informing the user that the recording of song take two of song part one has stopped, song take two has been added, providing details of song take two, providing instructions for a third song take, and/or providing instructions to add another song part. An exemplary message could be, e.g., “STOP BUTTON SELECTED”, “TAKE 2 FOR SONG PART 1 HAS BEEN ADDED” and/or “TAKE 2 FOR SONG PART 1 IS 30 SECONDS LONG”, and/or “SELECT START BUTTON TO BEGIN RECORDING TAKE 3 FOR SONG PART 1” and/or “SELECT ADD SONG PART BUTTON TO ADD ANOTHER SONG PART”, and/or “SELECT ADD SONG PART BUTTON TO ADD SONG PART 2”.

Alternatively, in response to user input selection of stop button 508, such as, e.g., a short click, a user device disclosed herein stops recording song take two of song part one. In this case, selection of stop button 508 stops recording of song take two and deletes this song take from memory, and a song take two button will not display adjacent to take one button 562. A user device may also enable display device 501 to display an indication to the user that the recording of song take two of song part one was stopped and deleted. For example, the user device may generate an audio signal and/or display a visual message in stop recording button 508 and/or song part one button 560 informing the user that the user device has stopped recording a song part. An exemplary message could be “RECORDING STOPPED AND DELETED”, “RECORDING TAKE STOPPED AND DELETED”, or “RECORDING TAKE TWO STOPPED AND DELETED.” The user device may also enable display device 501 to generate an audio signal and/or display a visual message in message window 526 informing the user that the recording of song take two of song part one has stopped and deleted. An exemplary message could be, e.g., “STOP BUTTON SELECTED AND TAKE 2 WAS DELETED”, “TAKE 2 FOR SONG PART 1 HAS BEEN DELETED” and/or “SELECT START BUTTON TO BEGIN RECORDING TAKE 2 FOR SONG PART 1” and/or “SELECT ADD SONG PART BUTTON TO ADD ANOTHER SONG PART”, and/or “SELECT ADD SONG PART BUTTON TO ADD SONG PART 2.”

In another embodiment, a user device as disclosed herein provides the capacity to add another song part, where a prior song part was previously established. With continued reference to FIG. 5D, in response to user input selection of add song part button 502, such as, e.g., a short click, a user device as disclosed herein generates, adds, and displays, via display device 501, song part two button 570. The user device may display song part two button 570 below song part one button 560. A user device may also enable display device 501 to display an indication to the user that song part two has been added. For example, the user device may generate a highlighted border and/or add a symbol and/or change the color of the background and/or change the color and/or word of song part two button 570. As another example, the user device may also generate an audio signal and/or display a visual message in song part two button 570 informing the user that the user device is enabled to record a song part. An exemplary message could be “RECORDING OFF”, ‘RECORDING UNENABLED”, “RECORDING NOT ENABLED”, OR “RECORDING ENABLED: NO.” As discussed above for song part one, song part two is assigned to a designated time position. Song part two has a start time, an end time and an overall length of time. As shown in FIG. 5D, because a song take has not been recorded for song part two, song part two does not have a designated time position. As shown in FIG. 5D, song part two is not enabled for recording. The user device may also enable display device 501 to generate an audio signal and/or display a visual message in message window 526 informing the user that add song part button 502 was selected and/or that song part two button 570 may be selected to enable recording of a song take for a song part. An exemplary message could be “ADD SONG PART BUTTON SELECTED” and/or “SONG PART 2 HAS BEEN ADDED” and/or “SELECT SONG PART 2 BUTTON TO ENABLE RECORDING OF TAKE 1 FOR SONG PART 2.”

In another embodiment, a user device as disclosed herein provides the capacity to enable recording another song take to a song part where a prior song take to that song part was previously recorded. With continued reference to FIG. 5D, in response to user input selection of song part two button 570, such as, e.g., a short click, a user device as disclosed herein enables recording for song part two. A user device may also enable display device 501 to display an indication to the user that song part two has been enabled. For example, the user device may generate a highlighted border and/or add a symbol and/or change the color of the background and/or change the color and/or word of song part two button 570. As another example, the user device may also generate an audio signal and/or display a visual message in song part two button 570 informing the user that the user device is enabled to record a song part. An exemplary message could be “RECORDING ENABLED”, “RECORDING TAKE ENABLED”, “RECORDING TAKE ONE ENABLED”, or “RECORDING ENABLED: YES.” The user device may also generate an audio, visual, or audiovisual message 526 informing the user that song part two is enabled and that the user may select the start button 506 in order to begin recording a song take from a song part. An exemplary message could be “SONG PART 2 BUTTON SELECTED” and/or “SONG PART 2 ENABLED FOR RECORDING” and/or “SONG PART 1 NOT ENABLED FOR RECORDING” and/or “SELECT START BUTTON TO RECORD TAKE 1 FOR SONG PART 2”, and/or “SELECT ADD SONG PART BUTTON TO ADD ANOTHER SONG PART”, and/or “SELECT ADD SONG PART BUTTON TO ADD SONG PART 2.”

In another embodiment, a user device as disclosed herein provides the capacity to initiate recording of a song take to a song part. Referring to FIG. 5E, in response to user input selection of start button 506, such as, e.g., a short click, a user device as disclosed herein initiates recording of song take one of song part two. A user device may also enable display device 501 to display an indication to the user that the recording of song take one of song part two has started. For example, the user device may generate a highlighted border and/or add a symbol and/or change the color of the background and/or change the color and/or word of start recording button 506 and/or song part two button 570. As another example, the user device may also generate an audio signal and/or display a visual message in start recording button 506 and/or song part two button 570 informing the user that the user device is recording a song part. An exemplary message could be “RECORDING”, “RECORDING TAKE”, or “RECORDING TAKE ONE.” Furthermore, the user device times the length of the recording of song take one of a song part and this information can be displayed in song time window 520 and/or song part two button 570. In addition, thumb 529 of scroll bar 528 has progressed to the right based on the current progress of the present recording. The user device may also enable display device 501 to generate an audio signal and/or display a visual message in message window 526 informing the user that song take one of song part two is being recorded and to stop the recording the user may select stop recording song take. An exemplary message could be “START BUTTON SELECTED” and/or “NOW RECORDING TAKE 1 FOR SONG PART 2” and/or “SELECT STOP BUTTON.”

In another embodiment, a user device as disclosed herein provides the capacity stop recording a song take to a song part. With continued reference to FIG. 5E, in response to user input selection of stop button 508, such as, e.g., a short click, a user device as disclosed herein stops recording song take one of song part two 570. A user device may also enable display device 501 to display an indication to the user that the recording of song take one of song part two has stopped. For example, the user device may generate a highlighted border and/or add a symbol and/or change the color of the background and/or change the color and/or word of start recording button 506 and/or song part two button 570. As another example, the user device may also generate an audio signal and/or display a visual message in stop recording button 508 and/or song part two button 570 informing the user that the user device has stopped recording a song part. An exemplary message could be “RECORDING STOPPED”, “RECORDING TAKE STOPPED”, or “RECORDING TAKE ONE STOPPED.” Furthermore, as shown in FIG. 5E, the user device can display, via display device 501, the total length of time of the recording in song time window 520 and/or song part two button 570. For example, at the point in time illustrated in FIG. 5K, the recording of song part one has progressed to 60 seconds, as indicated by song time window 520 or song part two button 570.

In response to the selection of stop button 508, the user device displays take one button 572 adjacent to song part two button 570. In addition, the user device assigns a designated time to song part two based on the length and the start time of song take one. That is, because the first song take of song part two (i.e., song take one) is 60 seconds in length and begins at time zero and ends 60 seconds later, each subsequent song take for song part two will be 60 seconds in length and will begin at time equal to zero. The user device may receive a request for song part to begin at a time other than zero, such as, e.g., time equal to two minutes. In this example, if song part two were to be assigned to start at time equal to two minutes, it should be appreciated that song part two would end at time equal to three minutes because song part two is 60 seconds in length.

The user device may also enable display device 501 to generate an audio signal and/or display a visual message in message window 526 informing the user that the recording of song take one of song part one has stopped, song take one has been added, providing details of song take one, providing instructions for a second song take, and/or providing instructions to add another song part. An exemplary message could be “STOP RECORDING BUTTON SELECTED” and/or “TAKE 1 FOR SONG PART 2 HAS BEEN ADDED” and/or “TAKE 1 FOR SONG PART 2 IS 1 MINUTE IN LENGTH” and/or “SELECT START RECORDING BUTTON TO RECORD TAKE 2 FOR SONG PART 2” and/or “SELECT ADD SONG PART BUTTON TO ADD ANOTHER SONG PART”, and/or “SELECT ADD SONG PART BUTTON TO ADD SONG PART 3.”

In another embodiment, a user device as disclosed herein provides the capacity to playback a song take from pre-recorded song parts. Referring to FIG. 5F, in response to user input selection of take two button 564 and take one button 572, such as, e.g., a short click, a user device as disclosed herein enables playback for song take two of song part one and song take one of song part two. Upon user selection of start button 506, such as, e.g., a short click, the user device will play at the same time the selected song takes (in this case song take two of song part one and song take one of song part two). The user device may also enable display device 501 to generate an audio signal and/or display a visual message in message window 526 informing the user that simultaneous playback and recording have been selected, providing information on which song takes and song parts were sleeted, and/or providing information on which song part is being recorded. An exemplary message could be, e.g., “SELECT START BUTTON TO PLAY BACK SELECTED TAKES” and/or “SELECT START TO PLAY BACK TAKE 2 OF SONG PART 1 AND TAKE 1 OF SONG PART 1” and/or “TAKE 2 OF SONG PART 1 AND TAKE 1 OF SONG PART 1 ARE PLAYING” and/or “TAKE 2 OF SONG PART 1 AND TAKE 1 OF SONG PART 1 ARE PLAYING BACK.”

In another embodiment, a user device as disclosed herein provides the capacity to like, edit, or delete a song take from a pre-recorded song part. Referring to FIG. 5G, in response to user input selection of take 2 button 564 of song part 1, such as, e.g., a long click, a user device as disclosed herein generates and displays, via display device 501, window 550 which includes like button 552, edit button 554, and delete button 556. User input then selects which of the three selections to implement. Upon selection of like button 552, a user device disclosed herein will designate a song take as preferred or favorite song take of all recorded song takes for a song part. A user device may also enable display device 501 to display an indication to the user that a particular song take was liked. For example, the user device may generate a highlighted border and/or add a symbol and/or change the color of the background and/or change the color and/or word of the text of take 2 button 564. Upon selection of edit button 554, a user device disclosed herein will allow user input to change or modify characteristics of a song take. For example, the edit feature can be used to change the default name from “Take 1” to a user preferred name, such as, e.g., “Smooth Guitar Riff.” Upon selection of delete button 556, a user device disclosed herein will remove take 2 button 564 from display device 501. The user device may also enable display device 560 to generate an audio signal and/or display a visual message in message window 526 informing the user that simultaneous playback and recording have been selected, providing information on which song takes and song parts were sleeted, and/or providing information on which song part is being recorded. An exemplary message could be, e.g., “SELECT LIKE BUTTON TO PICK TAKE AS FAVORITE” and/or “SELECT EDIT BUTTON TO EDIT TAKE DETAILS” and/or “SELECT DELETE BUTTON TO DELETE TAKE.”

In another embodiment, a user device as disclosed herein provides the capacity to add another song part, where a plurality of prior song parts was previously established. Referring to FIG. 5H, in response to user input selection of add song part button 502, such as, e.g., a short click, a user device as disclosed herein generates, adds, and displays, via display device 501, song part three button 580. The user device may display song part three button 580 below song part two button 570. A user device may also enable display device 501 to display an indication to the user that song part three 580 has been added. For example, the user device may generate a highlighted border and/or add a symbol and/or change the color of the background and/or change the color and/or word of song part three button 580. As another example, the user device may also generate an audio signal and/or display a visual message in song part three button 580 informing the user that the user device is enabled to record a song part. An exemplary message could be “RECORDING OFF”, ‘RECORDING UNENABLED”, “RECORDING NOT ENABLED”, OR “RECORDING ENABLED: NO.” As discussed above for song part one, song part three is assigned to a designated time position. Song part three has a start time, an end time and an overall length of time. The user device may also enable display device 501 to generate an audio signal and/or display a visual message in message window 526 informing the user that add song part button 502 was selected and/or that song part three button 580 may be selected to enable recording of a song take for a song part. An exemplary message could be “ADD SONG PART BUTTON SELECTED” and/or “SONG PART 3 HAS BEEN ADDED” and/or “SELECT SONG PART 3 BUTTON TO ENABLE RECORDING OF TAKE 1 FOR SONG PART 3.” Recording of a song take for song part three occurs in a manner similar to that discussed in connection with song parts one and two above.

In another embodiment, a user device as disclosed herein provides the capacity to simultaneously playback a song take from pre-recorded song parts while recording a song take from a different song part. With continued reference to FIG. 5H, in response to user input selection, a user device as disclosed herein generates, adds, and displays, via display device 560, song part three button 580 by selection of add song part button 502, such as, e.g., a short click, enables recording of a song take one of song part three by selection of song part three button 580, such as, e.g., a short click, as well as enables playback for song take two of song part one and song take one of song part two by selection of take two button 564 and take one button 572, such as, e.g., a short click. Upon user input selection of start button 506, such as, e.g., a short click, a user device as disclosed herein enables playback for song take two of song part one and song take one of song part two while simultaneously adding recording song take one of song part three. Thus, when song take one for song part three is being recorded, the user device will play at the same time the selected song takes (in this case song take two of song part one and song take one of song part two). Such a configuration enables a user to record a track while simultaneously listening to a previously recorded track or tracks. When recording subsequent song takes, only one song take for each song part may be requested to be played back. That is, the user device will not simultaneously play more than one song take for each given song part. The user device may also enable display device 501 to generate an audio signal and/or display a visual message in message window 526 informing the user that simultaneous playback and recording have been selected, providing information on which song takes and song parts were sleeted, and/or providing information on which song part is being recorded. An exemplary message could be, e.g., “FOR RECORDING OF SONG PART 3, TAKE 2 OF SONG PART 1 AND TAKE 1 OF SONG PART 1 WILL PLAY BACK.”

A user device as disclosed herein provides the capacity to execute an audition mode for a selected song part. For a selected song part, each song take is simultaneously played back with any other selected song takes from other song parts. The user device as disclosed herein further provides the capacity to receive a user request indicative of which song take at least one user favors. Such a configuration enables users to vote which song take for a song part mixes best with other designated song takes. FIGS. 6A-6D generally shows an example illustrating an audition mode for a selected song part.

In an embodiment, a user device as disclosed herein provides the capacity to upload a previously recording song from the home screen. Referring to FIG. 6A, as discussed above in FIG. 5A, in response to user input selection of song title window 622, such as, e.g., a long click, a user device as disclosed herein enables a user to select a previously recorded song stored on a database. In this example, the previously recorded song title “Jam” was selected from a database. Upon selection of the previously recorded song, a user device disclosed herein displays via display device 601 the selected song title in song title window 622 and all song parts and song takes for each song part associate with the selected song. For example, FIG. 6A displays song part one button 660, song part two button 670, song part three button 680, and song part four button 690. FIG. 6A also shows that 1) song part one has three recorded song takes (represented by song take one button 662, song take two button 664, and song take three button 666); 2) song part two has two recorded song takes (represented by song take one button 672 and song take two button 674); 3) song part three has two recorded song takes (represented by song take one button 682 and song take two button 684); and 4) song part four has three recorded song takes (represented by song take one button 692, song take two button 694, and song take three button 696). The user device may also enable display device 601 to generate an audio signal and/or display a visual message in message window 626 informing the user that the selected song has been loaded and is ready for further input. An exemplary message could be “SELECTED SONG LOADED.”

In another embodiment, a user device as disclosed herein provides the capacity to select one song take from one or more song parts not to be selected for audition mode. With continued reference to FIG. 6A, in response to user input selection, such as, e.g., a short click, a user device as disclosed herein displays, via display device 660, selected song takes that will be played in association with the song part desired to be auditioned. For example, as shown in FIG. 6A, the following song takes were enabled for playback: 1) song take two button 664 of song part one; 2) song take one button 672 of song part two; and 3) song take two button 684 of song part three. A user device may also enable display device 601 to display an indication to the user which song takes were selected. For example, the user device may generate a highlighted border and/or add a symbol and/or change the color of the background and/or change the color and/or word of the selected song takes. The user device may also enable display device 601 to generate an audio signal and/or display a visual message in message window 626 informing the user that audition mode has been opened. An exemplary message could be, e.g., “SONG TAKE TWO OF SONG PART ONE WAS SELECTED” and/or “SONG TAKE ONE OF SONG PART TWO WAS SELECTED” and/or “SONG TAKE TWO OF SONG PART THREE WAS SELECTED”

In another embodiment, a user device as disclosed herein provides the capacity to select one song take for audition mode. Referring to FIG. 6B, in response to user input selection of song part four 622, such as, e.g., a long click, a user device as disclosed herein generates and displays, via display device 601, window 640 which includes audition button 642, auto-record on 643, auto-record off 644, delete button 645, edit button 646, import button 648, and artist button 649. User input then selects which of the seven selections to implement. Upon selection of audition button 642, a user device disclosed herein will enable user to prepare the user device to select a song part for audition mode which will enable the user device to play each song take from that auditioned song part in association with the particular song takes selected from one or more of the remaining song parts. For example, in FIG. 6A, song part four 690 was selected in preparation for audition mode. Upon selection of auto-record on button 643, a user device disclosed herein will enable a user to automatically stop a subsequent song take recording one the specified time of song take one is reached. Upon selection of auto-play off button 644, a user device disclosed herein will enable a user to turn off auto-record on feature. Upon selection of delete button 645, a user device disclosed herein will delete a previously recorded song part stored in a database. Upon selection of edit button 646, a user device disclosed herein will enable the user to modify the text appearing in song part. Upon selection of import button 648, a user device disclosed herein will enable a user to load a music file stored in a database into a song take for that song part. Upon selection of artist button 649, a user device disclosed herein will enable a user to give assess privilege or permission to another user that allows the other user to add or delete song takes to that song part. The user device may also enable display device 601 to generate an audio signal and/or display a visual message in message window 626 informing the user that one of the seven selections was selected. An exemplary message could be, e.g., “SELECT AUDITION BUTTON TO AUDITION EACH TAKE OF SONG PART 4” and/or “SELECT AUTO-RECORD ON BUTTON TO ENABLE FEATURE” and/or “SELECT AUTO-RECORD OFF BUTTON TO DISABLE FEATURE” and/or “SELECT DELETE BUTTON TO DELETE SONG PART 4” and/or “SELECT EDIT BUTTON TO EDIT SONG PART 4” and/or “SELECT IMPORT BUTTON TO IMPORT ANOTHER SONG TAKE” and/or “SELECT ARTIST BUTTON TO ASSIGN ACCESS PREVILEDGE TO ANOTHER USER.”

With continued reference to FIG. 6B, in response to user input selection of audition button 642, such as, e.g., a short click, a user device as disclosed herein causes song part four to enter audition mode. In audition mode, each song take belonging to the selected song part for audition will simultaneously play in conjunction with the selected song takes form the other song parts. A user device may also enable display device 601 to display an indication to the user that audition mode has opened. For example, the user device may generate a highlighted border and/or add a symbol and/or change the color of the background and/or change the color and/or word of audition button 642. The user device may also enable display device 601 to generate an audio signal and/or display a visual message in message window 626 informing the user that audition mode has been started. An exemplary message could be, e.g., “AUDITION BUTTON FOR SONG PART 4 SELECTED” and/or “SELECT PLAY BUTTON TO LISTEN TO TAKE 1 OF SONG PART 4 ALONG WITH SELECTED SONG TAKES FROM OTHER SONG PARTS.”

In another embodiment, a user device as disclosed herein provides the capacity to play each song take from a song part in audition mode along with selected song takes from one or more other song parts. Referring to FIG. 6C, in response to user input selection of play 606, such as, e.g., a short click, a user device as disclosed herein causes the simultaneously playing of song take one of song part four in conjunction the following three song takes: 1) song take two from song part one; 2) song take one from song part two; and 3) song take two from song part three. A user device may also enable display device 601 to display an indication to the user that song take of a song part in audition mode is currently being played. For example, the user device may generate a highlighted border and/or add a symbol and/or change the color of the background and/or change the color and/or word of song take button 692. In addition, when song take one of song part four is being played, the user device enables a user to vote whether the user likes or dislikes song take one, via yes button 612 and no button 614. A user device may also enable display device 601 to display an indication to the user of the voting results. For example, the user device may generate a highlighted border and/or add a symbol and/or change the color of the background and/or change the color and/or word of yes button 612 and/or no button 614 as an indication of whether the song take received more yes votes than no votes. In this example, song take one did not receive any yes votes or no votes. A user device as disclosed herein may automatically play the next song take for a song part, after the previous song take has completed playing. However, in response to user input selection of next take button 610, such as, e.g., a short click, a user device as disclosed herein will immediately stop playing the currently played song take and begin to play the next song take. The user device may also enable display device 601 to generate an audio signal and/or display a visual message in message window 626 informing the user of audition mode status, voting results, and/or user options. An exemplary message could be, e.g., “SONG PART 4 IS IN AUDITION MODE” and/or “SONG TAKE 1 FOR SONG PART 4 IS BEING PLAYED” and/or “SELECT NEXT SONG TAKE BUTTON TO SKIP CURRENTLY PLAYED SONG TAKE” and/or “SELECT YES BUTTON OR NO BUTTON TO VOTE WHETHER YOU LIKE CURRENTLY PLAYED SONG TRACK.”

In another embodiment, a user device as disclosed herein provides the capacity to cycle to automatically play the next song take from a song part in audition mode. Thus, with continued reference to FIG. 6C, after song take one of song part four has completed playback, a user device as disclosed herein will automatically play song take two of song part four in conjunction the following three song takes: 1) song take two from song part one; 2) song take one from song part two; and 3) song take two from song part three. A user device may also enable display device 601 to display an indication to the user that song take of a song part in audition mode is currently being played. For example, the user device may generate a highlighted border and/or add a symbol and/or change the color of the background and/or change the color and/or word of song take button 694. Similarly to song take one, when song take two of song part four is being played, the user device enables a user to vote whether the user likes or dislikes song take one, via yes button 612 and no button 614. The user device may also enable display device 601 to generate an audio signal and/or display a visual message in message window 626 informing the user of audition mode status, voting results, and/or user options. An exemplary message could be, e.g., “SONG PART 4 IS IN AUDITION MODE” and/or “SONG TAKE 2 FOR SONG PART 4 IS BEING PLAYED” and/or “SELECT NEXT SONG TAKE BUTTON TO SKIP CURRENTLY PLAYED TAKE” and/or “SELECT YES BUTTON OR NO BUTTON TO VOTE WHETHER YOU LIKE THE CURRENTLY PLAYED SONG TRACK.”

In another embodiment, a user device as disclosed herein provides the capacity to save and count voting selections of local and remote users. Referring to FIG. 6D, in response to user input selection of yes button 612, such as, e.g., a short click, a user device as disclosed herein a user device as disclosed herein will save and count voting selection of local and/or remote users. A user device may also enable display device 601 to display an indication to the user of the voting results. For example, the user device may generate a highlighted border and/or add a symbol and/or change the color of the background and/or change the color and/or word of yes button 612 and/or no button 614 and/or song take button 694 as an indication of whether the song take received more yes votes than no votes. In this example, the user device displays a star in song take button 694 to the user indicating that song take two received more yes votes than no votes. It should be appreciate that is this example, at this point in time, song take two is the only song take to receive a vote. The user device may also enable display device 601 to generate an audio signal and/or display a visual message in message window 626 informing the user of audition mode status, voting results, and/or user options. An exemplary message could be, e.g., “YES BUTTON SELECTED” and/or “SONG TAKE 2 FOR SONG PART 4 IS PREFERRED TAKE.”

In another embodiment, a user device as disclosed herein provides the capacity to cycle to automatically play the next song take from a song part in audition mode after voting selection is completed. With continued reference to FIG. 6D, after song take two of song part four has completed playback, a user device as disclosed herein will automatically play song take three of song part four in conjunction the following three song takes: 1) song take two from song part one; 2) song take one from song part two; and 3) song take two from song part three. A user device may also enable display device 601 to display an indication to the user that song take of a song part in audition mode is currently being played. For example, the user device may generate a highlighted border and/or add a symbol and/or change the color of the background and/or change the color and/or word of song take button 696. Similar to song take one and song take two, when song take three of song part four is being played, the user device enables a user to vote whether the user likes or dislikes song take three, via yes button 612 and no button 614. The user device may also enable display device 601 to generate an audio signal and/or display a visual message in message window 626 informing the user that audition mode status and user options. An exemplary message could be, e.g., “SONG PART 4 IS IN AUDITION MODE” and/or “SONG TAKE 2 FOR SONG PART 4 IS BEING PLAYED” and/or “SELECT NEXT SONG TAKE BUTTON TO SKIP CURRENTLY PLAYED TAKE” and/or “SELECT YES BUTTON OR NO BUTTON TO VOTE WHETHER YOU LIKE THE CURRENTLY PLAYED SONG TRACK.”

FIG. 7 is a block diagram of an example data architecture 700. In this embodiment, data interface data 702, administrative data 704, and data 706 interact with each other, for example, based on user commands or requests. Interface data 702, administrative data 704, and data 706 may be stored on any suitable storage medium (e.g., database system 310 and/or server 280). It should be appreciated that different types of data may use different data formats, storage mechanisms, etc. Further, various applications may be associated with processing interface data 702, administrative data 704, and data 706. Various other or different types of data may be included in the example data architecture 700.

Interface data 702 may include input and output data of various kinds. For example, input data may include mouse click data, scrolling data, hover data, keyboard data, touch screen data, voice recognition data, etc., while output data may include image data, text data, video data, audio data, etc. Interface data 702 may include formatting, user device options, links or access to other websites or applications, and the like. Interface data 702 may include applications used to provide or monitor interface activities and handle input and output data.

Administrative data 704 may include data and applications regarding user accounts. For example, administrative data 704 may include information used for updating accounts, such as creating or modifying user accounts and/or host accounts. Further, administrative data 704 may include access data and/or security data. Administrative data 704 may include a terms of service agreement. Administrative data 704 may interact with interface data in various manners, providing user device 304 with administrative features, such as implementing a user login and the like.

Data 706 may include, for example, song part data 708, song take data 710, musician interface data 712, voting data 714, user data 716, application program data 718, content data 720, statistical data 722 and/or historical data 724. Other data may be included as represented by other data 726.

Song part data 708 may include data representative of at least one of a chordophone part, an aerophone part, a idiophone part, a membranophone part, an electrophone part, a keyboard part, or a vocal part. In aspects of this embodiment, a song part includes a string part like a guitar part, a bass part, a violin part, a viola part, a cello part, a harp part; a percussion part like a drum part, a bass drum part, a bongo part; a woodwind part like a clarinet part, a flute part, a horn part, an oboe part, a saxophone part, a trombone part, a trumpet part, or a tuba part; or a keyboard part like a piano part, an organ part. Song part data 708 may also include data representative of assigned time data or a length of time which is assigned or associated with the song part.

Song take data 710 may include data representative of audio data and/or data representative of song length.

Musician interface data 712 may include at least one of data representative of: the location of the musician device; the type of musician device; the operating system of the musician device; the version of the operating system of the musician device; the unique identifier of the musician device; the language employed by the musician device.

Voting data 714 may include data representative of a yes vote, a no vote, a total yes vote, a total no vote, a thumbs up vote, a thumbs down vote, a like vote, a dislike vote.

User data 716 may include data representative of user profile data such as, e.g., name of user, gender of the user, and contact information like email address or telephone number.

Application program data 718 may include applications which may be downloaded or requested by the realtor interface. Applications may be designed to help a user to perform specific tasks. Applications may include enterprise software, accounting software, office suites, graphics software and media players.

Content data 720 may include any suitable content such as audio data, video data and/or image data.

Statistical data 722 may include data used for providing reports including graphs, forecasts, recommendations, calculators, depreciation schedules, tax information, etc., including equations and other data used for statistical analysis.

Historical data 724 may include past data representative of: past sales data, historical list prices, actual sale prices, etc.

It should be appreciated that data may fall under one or more categories of data 706, and/or change with the passage of time.

It should be appreciated that a system administrator may load data 706 into the information processing system 702 as it becomes available. It should also be appreciated that data 706 may be tailored for a particular information processing system, for example, a musician may request that a specific type of data that is not normally stored or used be stored in the database system 310.

Data 706 may be maintained in various servers 140, in databases or other files. It should be appreciated that, for example, a user device 104 may manipulate data 706 based on administrative data 704 and interface data 702 to provide requests or reports to users 114 and perform other associated tasks.

Regarding the exemplary embodiments of the present invention as shown and described herein, it will be appreciated that a system and methods for managing audio recordings is disclosed. Because the principles of the invention may be practiced in a number of configurations beyond those shown and described, it is to be understood that the invention is not in any way limited by the exemplary embodiments, but is generally directed to a system and methods for managing audio recordings and is able to take numerous forms to do so without departing from the spirit and scope of the invention. It will also be appreciated by those skilled in the art that the present invention is not limited to the particular structures or modules disclosed, but may instead entail other functionally comparable structures, now known or later developed, without departing from the spirit and scope of the invention. Furthermore, the various features of each of the above-described embodiments may be combined in any logical manner and are intended to be included within the scope of the present invention.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The method as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor believes that the claimed subject matter is the invention.

What is claimed is:

1. A method for recording and managing a plurality of sound takes for an at least one sound part associated with a sound project, each sound part having a respective start time and an end time, the method comprising the steps of:
implementing a database in memory on an at least one user device, the database configured for selectively storing each of the sound takes for the at least one sound part of the sound project;
allowing a primary user, via the user device, to selectively add at least one sound part to the sound project;
allowing the primary user, via the user device, to selectively record at least one sound take for a given sound part;
allowing the primary user to select one of the previously recorded sound takes for each of the at least one sound parts for simultaneous playback during the recording of any new sound takes; and
upon the primary user choosing to record a new sound take for a given sound part,
determining whether the new sound take is a first sound take to be recorded for the associated sound part;
upon determining that the new sound take is the first sound take to be recorded for the associated sound part, recording the sound take as the first sound take for the sound part and setting the start time and end time associated with the sound part based on an overall length of the recorded first sound take;
upon determining that the new sound take is not the first sound take to be recorded for the associated sound part, recording the sound take as a subsequent sound take for the sound part; and
simultaneously playing back any selected previously recorded sound takes for each of the at least one sound parts during the recording of the new sound take.

2. The method of claim 1, further comprising the step of displaying, via a display of the primary user device, each sound part of the sound project along with the sound takes associated with each sound part, thereby allowing the primary user to visually select one of the previously recorded sound takes for each sound part for simultaneous playback during the recording of any new sound takes and for choosing which sound takes to include in a final version of the sound project.

3. The method of claim 1, further comprising the step of allowing the primary user to selectively adjust the start time and end time of a given sound part.

4. The method of claim 1, further comprising the step of allowing the primary user to selectively adjust the latency of a previously recorded song take.

5. The method of claim 4, wherein the step of allowing the primary user to selectively adjust the latency of a previously recorded song take further comprises the step of allowing the primary user to selectively adjust the start time of the associated song part in order for said song take to coincide with the timing of other song parts.

6. The method of claim 1, further comprising the step of allowing the primary user to audition at least one song take for one or more secondary users so that said secondary users may vote for a favorite song take.

7. The method of claim 6, further comprising the steps of:
allowing the primary user to select one of the previously recorded sound takes for each of the at least one sound parts for simultaneous playback during the audition;
receiving a vote from each secondary user as to which song take each secondary user prefers;
tallying the votes received from each secondary user; and
notifying the primary user as to which sound take received the most votes.

8. The method of claim 1, further comprising the step of allowing an at least one secondary user to visually select one of the previously recorded sound takes for each sound part for choosing which sound takes to include in a final version of the sound project.

9. A system for recording and managing a plurality of sound takes for an at least one sound part associated with a sound project, each sound part having a respective start time and an end time, the system comprising:
an at least one user device comprising a processor and a computer-readable storage medium storing computer-executable instructions that when executed by the processor cause the user device to:
implement a database in memory on the at least one user device, the database configured for selectively storing each of the sound takes for the at least one sound part of the sound project;
allow a primary user, via the user device, to selectively add at least one sound part to the sound project;
allow the primary user, via the user device, to selectively record at least one sound take for a given sound part;
allow the primary user to select one of the previously recorded sound takes for each of the at least one sound parts for simultaneous playback during the recording of any new sound takes; and
upon the primary user choosing to record a new sound take for a given sound part,
determine whether the new sound take is a first sound take to be recorded for the associated sound part;
upon determining that the new sound take is the first sound take to be recorded for the associated sound part, record the sound take as the first sound take for the sound part and set the start time and end time associated with the sound part based on an overall length of the recorded first sound take;
upon determining that the new sound take is not the first sound take to be recorded for the associated sound part, record the sound take as a subsequent sound take for the sound part; and
simultaneously play back any selected previously recorded sound takes for each of the at least one sound parts during the recording of the new sound take.

10. A method for recording and managing a plurality of sound takes for an at least one sound part associated with a sound project, each sound part having a respective start time and an end time, the method comprising the steps of:
implementing a database in memory on an at least one user device, the database configured for selectively storing each of the sound takes for the at least one sound part of the sound project;
allowing a primary user, via the user device, to selectively add at least one sound part to the sound project;
allowing the primary user, via the user device, to selectively record at least one sound take for a given sound part;
allowing the primary user to select one of the previously recorded sound takes for each of the at least one sound parts for simultaneous playback during the recording of any new sound takes;
upon the primary user choosing to record a new sound take for a given sound part,
determining whether the new sound take is a first sound take to be recorded for the associated sound part;
upon determining that the new sound take is the first sound take to be recorded for the associated sound part, recording the sound take as the first sound take for the sound part and setting the start time and end time associated with the sound part based on an overall length of the recorded first sound take;
upon determining that the new sound take is not the first sound take to be recorded for the associated sound part, recording the sound take as a subsequent sound take for the sound part; and
simultaneously playing back any selected previously recorded sound takes for each of the at least one sound parts during the recording of the new sound take; and
allowing the primary user to audition at least one song take for one or more secondary users so that said secondary users may vote for a favorite song take.
